(19) United States
(12) Patent Application Publication
(10) Pub. No.: US 2008/0235177 A1
(43) Pub. Date: Sep. 25, 2008

(54) System and method for analyzing corporate regulatory-related data

(76) Inventors: Jong Young Kim, Belmont, CA (US); Chakrapani Cherukuri, Foster City, CA (US); Daniel Radzinski, Ramat-Efal (IL); Gangadhar Kotte, Fremont, CA (US)

Correspondence Address: Maier & Maier, PLLC, 1000 Duke Street, Alexandria, VA, 22314, US

(21) Appl. No.: 11/723,834

(22) Filed: Mar. 22, 2007

(51) Int. Cl. G06F 17/30; G06F 17/00; G06F 7/00

(52) U.S. Cl. 707/1; 707/3; 707/104.1

(57) ABSTRACT

A system, computer program product and method for categorizing, storing, accessing, returning, displaying and analyzing corporate regulatory-related data is disclosed. Embodiments may include accessing corporate regulatory-related data from one or more storage mediums having plurality of corporate regulatory-related data, HTML tags and/or source documents. Also embodiments may include returning corporate regulatory-related data that may be responsive to a search query. Moreover, embodiments may access a captured portion of a source document containing the corporate regulatory-related data in response to the user selecting a corporate regulatory-related data.

### FIELD

This invention relates generally to systems and methods for manipulating and analyzing various types of information that entities produce. More particularly, embodiments of the present invention relate to computer-implemented systems and methods for categorizing, storing, accessing, returning, displaying and analyzing corporate information such as corporate regulatory-related data.

### BACKGROUND

In the post-Sarbanes-Oxley era of the United States Securities and Exchange Commission (“SEC”), independent analysis of the various types of information that entities, specifically, public companies are required and, additionally, voluntarily disclose to the SEC is beneficial for many interested parties such as compensation consultants, executives, executive recruiters, attorneys, investors, bankers, members of the media, the companies themselves, other entities, etc. As a result, increased confidence in any independent analysis along with increased confidence in the underlying data is also beneficial.

The SEC maintains the Electronic Data Gathering, Analysis and Retrieval system (“EDGAR”) to perform certain automated collection, validation, indexing, acceptance and forwarding of submissions by companies and others who are required by law to submit filings with the SEC. Companies, foreign and domestic, are required to file registration statements, periodic reports and other forms electronically through EDGAR. Thus, various filings may be accessed and downloaded by the public on EDGAR. Nevertheless, analysis may require identifying and downloading certain filings, locating and integrating multiple data sources, transferring numerical values and text into report documents and performing complex calculations such as using Black-Scholes and Binomial Lattice formula (e.g., for grant date present value of options).

The following patent publications illustrate and describe various background systems and methods. U.S. Pat. No. 7,089,229 and U.S. Pub. No. 2006/0190451 A1 (Goldman et al.) teaches a system and method for locating a number in a source document by presenting and manipulating data on private and public companies. U.S. Pat. No. 6,862,596 (Thomsen) teaches a system and method for retrieving and displaying data, such as economic data. U.S. Pat. No. 6,373,270 (Maimon et al.) teaches a corporate disclosure and repository system that includes one or more software programs which execute on one or more general purpose data processing systems. U.S. Pat. No. 6,122,635 (Burakoff et al.) teaches a system for providing access to compliance information that includes a subsystem for acquiring securities information from one or more database sources. U.S. Pat. No. 6,078,924 (Ainsbury et al.) teaches an information platform that automates the collection of data, provides analysis using multiple content-types, thereby providing a user with a market understanding necessary to execute a rapid and knowledgeable decision making. US Pub. No. 2004/0133501 A1 (Parry et al.) teaches a communication system for producing electronic business information reports. US Pub. No. 2003/0145015 A1 (Tumasella) teaches a system and method for providing salary data to a self designated survey group. US Pub. No. 2002/0188542 A1 (Zhang et al.) teaches an invention relating to processing compensation data and in particular, to processing compensation data stored according to different data models. US Pub. No. 2001/0049706 A1 (Thorne) as well as UK Pat. App. GB 2362972 A (Thorne) teach document indexing systems.

### SUMMARY

An embodiment of the present invention discloses a system and method for identifying, storing and returning corporate regulatory-related data. The embodiment may include identifying a plurality of corporate regulatory-related data and generating a plurality of HTML tags for the plurality of corporate regulatory-related data. Optionally, the embodiment may include storing the plurality of HTML tags in one or more databases. The embodiment may also return corporate regulatory data in response to search queries.

Another embodiment of the present invention discloses a computer program product for returning corporate regulatory-related data. The embodiment may include a computer storage medium and a computer program code mechanism embedded in the computer storage medium. The computer program mechanism may include a computer code device configured to: receive a search query defined by at least one search criteria; run the search query against a plurality of corporate regulatory-related data; return a report having corporate regulatory-related data; allow for the selection of the corporate regulatory-related data; and return a captured portion of an source document having corporate regulatory-related data.

Yet another embodiment of the present invention discloses a system and method for searching and analyzing corporate regulatory-related data. The embodiment is, preferably, in a distributed network and may include entering a user-generated search query from one or more client computers. Optionally, the embodiment may include accessing corporate regulatory-related data from one or more storage mediums having a plurality of corporate regulatory-related data, HTML tags and captured portions of source documents. A report may be displayed containing corporate regulatory-related data to one or more client computers and it may be responsive to a user selecting corporate regulatory-related data from the one or more client computers. Additionally, it may access a captured (e.g., having a HTML tag(s)) portion of a source document containing the corporate regulatory-related data in response to the user selecting a corporate regulatory-related data. Optionally, the report may be downloaded and the corporate regulatory-related data therein may be linkable to portions of the source documents.

In other embodiments, the corporate-regulatory related data may be a numerical value computed by two or more component numerical corporate regulatory-related values. Upon selection of the numerical value, a user may view the component numerical values that are linkable to portions of the source documents.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing a computer system.

FIG. 2 is an exemplary diagram showing a system architecture.

FIG. 3 is an exemplary figure showing a portion of a search query interface.

FIG. 4 is an exemplary figure showing a portion of a report interface.

FIG. 5 is an exemplary figure showing a calculation diagram/chart as well as a calculation pie chart.

FIG. 6 is an exemplary figure showing a captured portion(s) of a filing.

FIG. 7 is an exemplary figure showing a spreadsheet.

FIG. 8 is an exemplary figure showing a portion of an interface having a captured portion of a filing.

FIG. 9 is another exemplary figure showing a portion of a report interface.

FIG. 10 is another exemplary figure showing a calculation diagram/chart.

FIG. 11 is another exemplary figure showing a portion of a report interface.

FIG. 12 is an exemplary figure showing a captured portion(s) of a filing.

FIG. 13 is another exemplary figure showing a captured portion(s) of a filing with a highlighted section.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

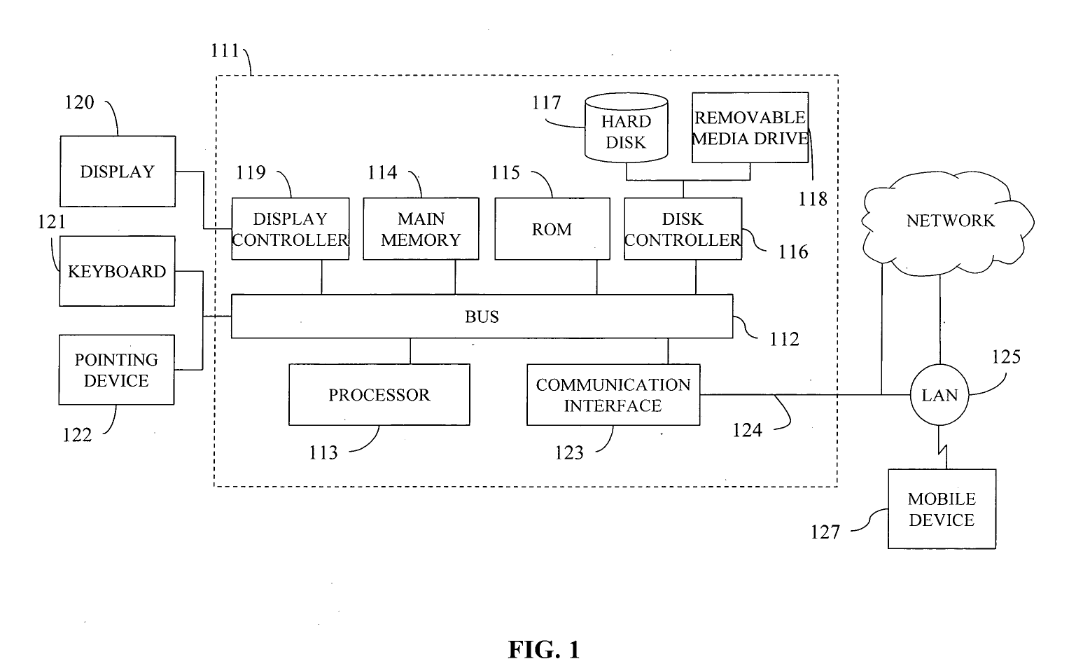

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, Oracle, SQL Server, My SQL, ACCESS, etc.), an object-oriented database management system (ODBMS), a file system or another conventional database package as a few non-limiting examples. The databases can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer user. The computer system may include input devices, such as a keyboard 121 and a pointing device 122, for interacting with a computer user and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., a LAN) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

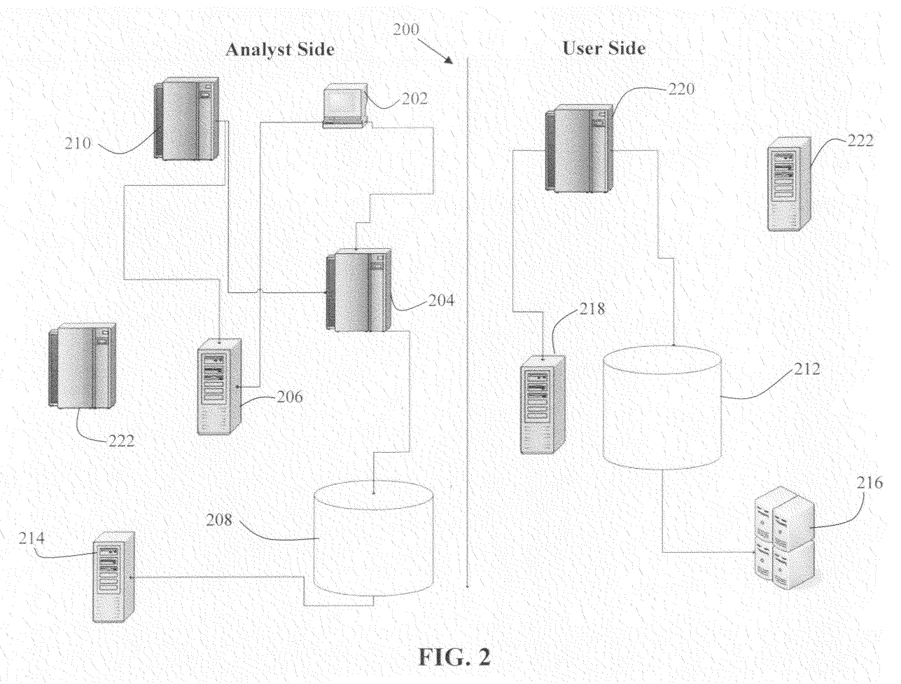

FIG. 2 is an exemplary diagram showing at least one exemplary embodiment of a system for identifying, storing and returning, as one non-limiting example, corporate regulatory-related data to a client. Those having ordinary skill in the art will understand that embodiments of the present invention are not limited to corporate regulatory-related data, rather that embodiments may be used with any type of information produced by both public and private entities contained in various electronic document formats whether the documents are publicly accessible or not. Thus, it is not the intention of the inventor to limit embodiments of the invention to particular types of information or to limit it to information that is required to be submitted to regulatory agencies such as the SEC. For illustrative purposes, embodiments of the present invention will be described in relation to corporate regulatory-related data.

Corporate regulatory-related data includes data contained within, but is not limited to, all mandatory or voluntary SEC filings (disclosures) such as DEF 14A filings (also referred to as “Proxy” filings), 8-K filings, Form 4 filings, 10-K filings, 10-Q filings and the like as well as press releases and other corporate statements and the like known to one having ordinary skill in the art. Corporate regulatory-related data not only includes all data contained within SEC filings but also all data contained within all filings to any regulatory agency domestic or foreign. Corporate regulatory-related data, when appropriate, also refers to whole filing documents and not just a portion of the data contained therein. Moreover, corporate regulatory-related data may be in, but is not limited to, numerical form, textual form and a combination of the both. It is contemplated by the inventor that both numerical and textual data will be used with embodiments of the present invention.

Referring first to the analyst side of FIG. 2 that shows system 200 that may have one or more client computers 202 that may be networked with one or more application servers 204 and, optionally, one or more file servers 206. The system 200 may make use of Linux and Windows operating systems, J2EE technologies and Oracle databases as a few non-limiting examples. Client 202 may contain all or part of a software application (e.g., desktop application) for identifying and/or categorizing corporate regulatory-related data through the use of tags. Alternatively, all or part of the software application (computer program) may be contained on application server 204 accessible to client 202. Likewise, source documents may be contained on client 202 or may be contained on file server 206 accessible to client 202. Source documents may be provided to file server 206 through various means including transferring SEC filings from EDGAR and the like or using third-party vendors.

A software application(s) accessible to client 202 may be used by one or more analysts to identify and “tag” corporate regulatory-related data contained within source documents, for example, SEC filings that may be, for instance, formatted as HTML documents. An exemplary software application may be refer to as a HTML Filing Editor program when used for source documents formatted as HTML documents. For example, an exemplary HTML Filing Editor program can be created using graphical user interface (GUI) widget toolkits such as Standard Widget Toolkit (SWT), Abstract Window Toolkit (AWT) or Swing as a few non-limiting examples. As a result, the SWT browser control is an Object Linking and Embedding (OLE) wrapper for Internet Explorer (Microsoft) and any actions with HTML filings, such as “tagging” (e.g., by “drag & drop” functionality), “jump-to” functionality and highlighting selections functionality can happen through the SWT Browser.execute( ) method by passing JavaScript that deal with Internet Explorer's DHTML objects, properties and methods.

Displaying a source HTML document may be accomplished by the HTML Filing Editor program by allowing an analyst to open a “tagging” window and display source documents within the “tagging” window. Also, an exemplary program may be configured to check if the document is locked (i.e. it is currently opened on a client computer) and may be configured to deliver a “read-only” prompt allowing an analyst to select to open the document in “read-only” mode. If not locked, an analyst may check out (lock) the source document and obtain exclusive access. An exemplary program may also provide a view mode for the “tagging” window in order to display source documents in “read-only” mode. Also, after opening a selected source document, a jump-to script (e.g., JavaScript) may be executed and previously selected corporate regulatory-related data may be shown using an associated bookmark that can be regenerated using, for example, offset and length.

When the source document is closed, it can be saved and checked in. For example, when an analyst tries to close the “tagging” window, the program can save, optionally, after prompting the analyst, and check-in all checked-out source documents. When saving, the “tagged” source document may overwrite the original source document.

Once the “tagging” window is open, an exemplary HTML Filing Editor program may accomplish “tagging”, for example, by “drag & drop” functionality by being configured to allow an analyst to select an identified corporate regulatory-related data from a source document and “drag & drop” (e.g., by using a mouse, touchpad and like point and click devices) the selected corporate regulatory-related data into, for example, a cell in a popup grid control within the “tagging” window or another window. Optionally, the program may allow or prompt an analyst to either reject or accept the selection. If the selection is accepted, the following actions may be performed (e.g., by executing JavaScripts to use Internet Explorer's DHTML objects, properties and methods as one non-limiting example) in order to insert bookmarks and highlight the selection, including: optionally expanding the selection to cover whole words to avoid inserting the bookmark in the middle of a word and causing detection problems for a parser; inserting “START” bookmark using a generated unique bookmark ID at the beginning of the selected corporate regulatory-related data; inserting “END” bookmark using a generated unique bookmark ID at the end of the selected corporate regulatory-related data (the same bookmark ID may be used for the “START” and “END” bookmarks); creating a TextRange to cover the selection (i.e. from “START” to “END”) and can also change the font color, for example, by use of a DHTML method. The generated bookmark ID may then be saved as a drilldown object for each selected corporate regulatory-related data item and thereafter may be saved into one or more first databases 208 when, for example, saved in the “tagging” window. If not saved, it may be flagged as “dirty” so that the “Save” action can be fired when an analyst attempts to closed the HTML Filing Editor application.

Timestamps can be used as one non-limiting example for generating unique bookmark IDs, for example, such as specifying that: (1) offset: “1yyDDDHHHmm”; (2) length: “1ssSSS”; start bookmark ID: “E_Q_B_M_”+offset+“_”+length+“_START”; end bookmark ID: “E_Q_B_M_”+offset+“_”+length+“_END”. Other methods known to one having ordinary skill in the art can also be used for generating unique bookmark IDs. Changing the font color of highlighted section, for example, by using a DHMTL method may prove beneficial and may be performed by an exemplary HTML Filing Editor program. For example, red (“#fa3614) may be used for most selections of less than 80 characters, green (“#118115”) may be used for most selections for 80 or more characters, and blue (“#3a1abf”) may be used for any selections that overlap with any previous selections. Of course, any other color coded scheme and corresponding selection rules may be implemented.

Running the parsers may be accomplished by checking if the source document is locked. If locked, then parse action may be disabled for the source document. If unlocked or if closed so as to be unlocked, then the source document may be checked out. Once checked out, the server is called for a parser and when the parse results are returned. The HTML Filing Editor program can insert bookmarks based on the location (e.g., offset and length) that the parser returns.

Therefore, analysts may “tag” portions of the source documents representing corporate regulatory-related data of interest by identifying the corporate regulatory-related data of interest and optionally using a “drag” and “drop” feature of the software application that may effectuate storing of the tags in one or more first databases 208. Software application using other methods or features beside “drag” and “drop” for “tagging” may also be used and are well known to one having ordinary skill in the art. First database 208 may be an Oracle database(s) or any other suitable database known to one having skill in the art. While “tagging”, for example, by using a “drag” and “drop” feature, the software application may preserve the source of the corporate regulatory-related data by using HTML tags, for instance, custom HTML tags configured for such a purpose. These tags can be contained in the HTML filing documents themselves and/or stored separately in first database 208. The HTML filing documents then may also be stored in database 208 along with meta data such as company name, filing type, name of filing, etc or, alternatively, the source documents may remain on file server 206. Even if source documents remain on file server 206, the meta data associated therewith can still be stored in first database 208. Preferably, database 208 will store HTML tags in a robust and reliable manner.

Optionally, system 200 may include one or more parsers that may automatically identify corporate regulatory-related data. These parsers may be contained on client 202 or servers 204 and 206 as well as on one or more additional servers 210 that can be configured to run the parser program and/or script(s). Servers 210 may also be networked with servers 204 and 206 as well as database 208 and the parsed corporate regulatory-related data may also be preserved by using HTML tags such as custom HTML tags configured for such a purpose. As a quality control measure, for example, analysts may review corporate regulatory-related data that has been parsed to increase the probability that it is accurate and complete as well as review any other “tagged” corporate regulatory-related data.

Although the analyst side shown in FIG. 2 may contain or may be configured to contain all the necessary components for accessing and using the identified corporate regulatory-related data, in practice it may be preferably to transfer all or some of the HTML tags that are stored in, for example, first database 208 to one or more second databases 212 on the user side of FIG. 2. Second database 212 may also be an Oracle database or any other suitable database known to one having ordinary skill in the art. Transferring the data from first database 208 to second database 212 may be accomplished through the use of one or more servers such as server 214 that can contain a data migration program and/or script(s). For example, Extract Transform and Load (ETL) scripts may cause the HTML tags to be transferred from a first Oracle database 208 and loaded onto a second Oracle database 212. Also, optionally, one or more data feeds 216 can be networked to database 212 to provide a subset or all of the corporate regulatory-related data directly to specific parties. For example, a party who may directly want corporate regulatory-related data for specific companies can be the recipient of data feed 216. Additionally, the corporate regulatory-related data can be provided shortly after it is captured. Additionally, system 200 may have one or more backup servers 222 on the analysts and/or user side of system 222.

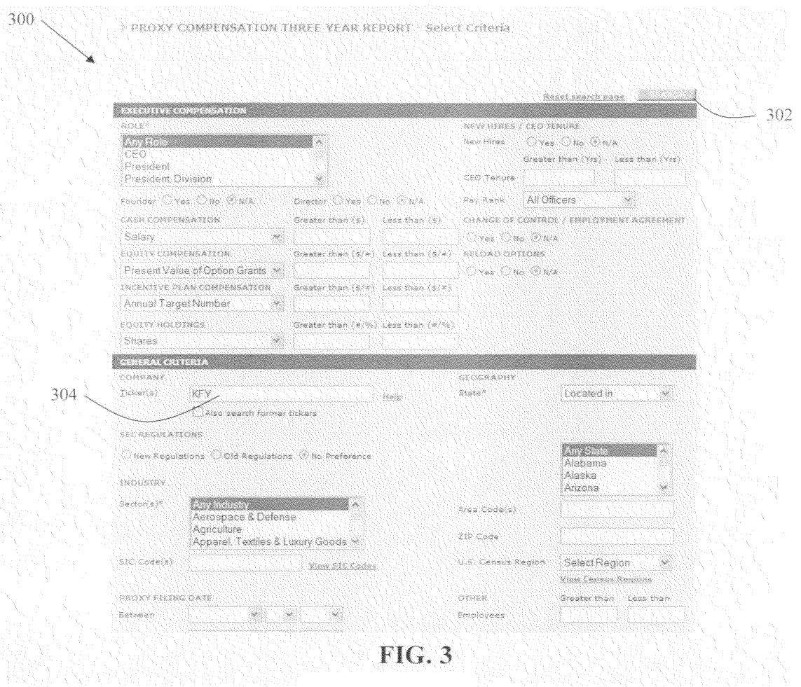

Referring to the user side shown in FIG. 2, database 212 may be networked with one or more second file servers 218 and one or more second application servers 220. Although not shown in FIG. 2, database 212, file server 218 and application server 220 may be networked and accessible to one or more second client computers, for example, via the Internet. The file server may contain copies of the source documents in original form, a modified form (e.g., due to “tagging”), or both. The second client computers and/or application server 220 may contain all or part of a software application for analyzing corporate regulatory-related data. The software application is the focus of remaining FIGS. 3-13 showing exemplary figures of which, numerous exemplary figures depict exemplary embodiments that may be displayed by various graphical user interfaces or portions thereof and is, thus, described in further detail below. It will be understood by one having ordinary skill in the art that although numerous figures may appear to call for the use of web-based applications for viewing, for instance, in an web browser with an exemplary graphical user interface, embodiments of the invention are not so limited and that many software embodiments are capable of being used and/or made in accordance with the present invention and, moreover, web-based embodiments may be displayed by any graphical user interface known to one having ordinary skill in the art.

Embodiments of this software application may make use of the HTML tags, for instance, custom HTML tags that may be contained in the source documents (e.g., SEC filings) themselves, for example, on a file server and/or tags may also be separately stored in one or more databases, alternatively, also along with the source documents. For example, the source HTML documents may be stored on file server 218. The location and the characteristics of the HTML documents can be stored on second database 212, which can be a relational database. Embodiments of the software application may allow a user on a client computer (e.g., in a distributed environment) to run various searches, return various reports, download various reports, link to the source HTML documents or portions thereof and the like known to one having ordinary skill in the art. Particularly, the software application may use the HTML tags to show a user where the corporate regulatory-related data is found within the source HTML document such as portions of SEC filings.

For example, an exemplary software application will respond to a user selecting a corporate regulatory-related data and drilldown information such as document ID, offset and length can be retrieved from a database such as second database 212. The source document, for instance, a SEC filing in HTML format can be read from a file server, for example, file server 218 and the application may search for the START bookmark that may have been generated by an HTML Filing Editor program. An exemplary application may change font color to black except for the current drill down range by replacing any color codes used by the HTML Filing Editor program with black color codes for any matches outside of the drilldown range represented by the selection of a specific corporate regulatory-related data.

FIGS. 3-8 generally refer to, as one non-limiting example, exemplary embodiments directed to various compensation received by executives of public companies as reported in one or more Proxy filings. As discussed above, these exemplary embodiments are merely illustrative and one having ordinary skill in the art will understand that embodiments of the invention may be used to analyze various types of information produced by public and non-public entities including a plurality of corporate regulatory-related data. It can be note here that executive compensation refers to various types of compensation that may be received by officers, directors or any other such persons that may have substantial decision-making authority for a company.

FIG. 3 shows one exemplary portion of a search query interface of at least one exemplary embodiment having search functionality that may be configured to receive numerous types of search criteria and may have numerous search parameters and the like known to one having ordinary skill. For example, in the viewable portion of search query interface 300 depicted by FIG. 3 is shown, among others, “Search” button 302, executive's “Role”/position list box, “Founder” radio buttons, “Director” radio buttons, “Cash Compensation” type drop down menu, “Equity Compensation” drop down menu, “Incentive Plan Compensation” drop down menu, “Equity Holdings” drop down menu, dollar amount data entry fields defining parameters, “New Hires” radio buttons, “CEO Tenure” data entry fields defining parameters, “Pay Rank” drop down menu, “Change of Control/Employment Agreement” radio buttons, “Reload Options” radio buttons, company stock “Ticker” data entry field 304 and a checkbox option for also searching former tickers, “SEC Regulations” radio buttons, industry “Sector(s)” list menu, “SIC Code(s)” data entry field, “Proxy Filing Date” drop down menus defining parameters, “State” drop down menu and list menu, “Area Code(s)” data entry field, “Zip Code” data entry field, “U.S. Census Region” drop down menu, and number of “Employees” data entry fields defining parameters. All such parameters, fields, menus, lists, buttons, boxes and other widgets may be used conjunctively and in various combinations. Of course, other parameters, fields, menus, lists, buttons, boxes, widgets, hyperlinks and the like known to one having ordinary skill in the art may be added or removed in further embodiments.

As shown in stock “Ticker” data entry field 304, ticker symbol “KFY” can be entered by keystroke or selected from a pop-up window/menu (not shown), which may be a popup that dynamically appears and, after the selection of a displayed ticker symbol, disappears. “KFY” is the stock ticker for “Korn Ferry International” and a search of the information on executive compensation for Korn Ferry International may be executed by selecting “Search” button 302 disposed on search query interface 300.

Optionally, a user may be directed to a second exemplary interface that functions as an intermediate between the search query entered in interface 300 and a report interface, a portion of which is shown in interface 400 (described below). This interface may allow a user to review the search criteria and results and then decide on whether the user may want to run a report. For example, a data field may display the number of executives found as a result of the search criteria, for instance, “4 executives matched.” Also, selected criteria data fields may display information about the search criteria and parameters, for instance, in our exemplary search of “KFY”, the data field may show that employment agreement, director parameter, founder parameter, new hire parameter and the like are not applicable to this search query while a ticker symbol data field shows “KFY” corresponding to the search criteria entered within interface 300. Moreover, interface widgets (e.g., buttons), hyperlinks, hyperlinked pop up windows/menus and the like known to one having ordinary skill in the art may provide for “Check All” functionality, “Clear All” functionality, “Edit Criteria” functionality and “Run Report” functionality relating to the search criteria.

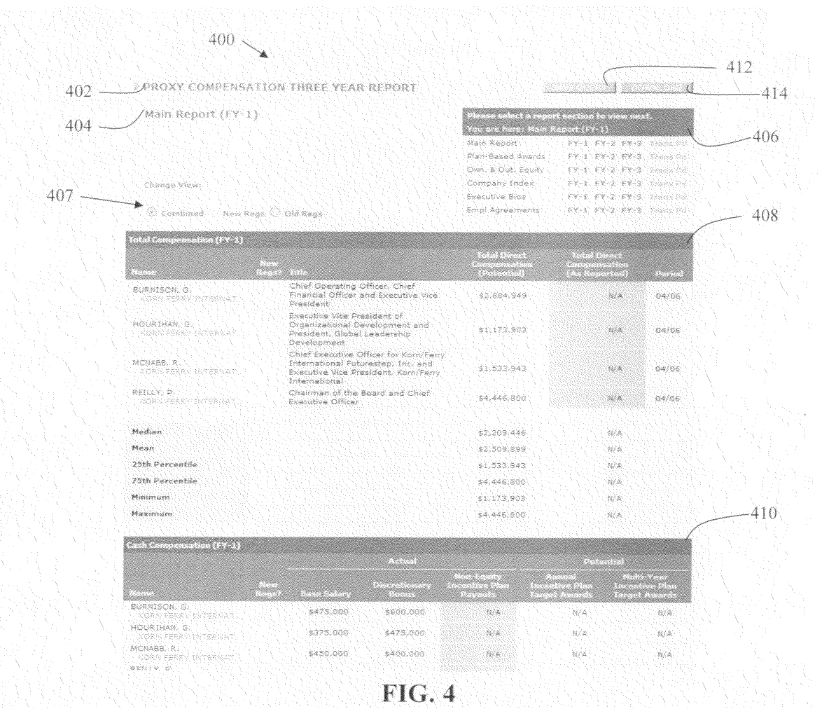

Moreover, a search result(s) data fields may display information relating to companies that are searched such as company name, ticker symbol, revenues, current market capital, SIC code, etc. Additionally, checkboxes may be disposed on the second exemplary interface for selecting or deselecting the one or more companies listed and interface widgets, hyperlinks, hyperlinked pop up windows/menus and the like may provide for “Check All” functionality, “Clear All” functionality, “Edit Criteria” functionality and “Run Report” functionality and the like known to one having ordinary skill in the art. A user that selects, for example, a “Run Report” button after reviewing the criteria and results may be directed to an interface such as the exemplary interface shown in FIG. 4.

FIG. 4 shows a portion of an exemplary interface of at least one exemplary embodiment that may return and display a report (or portion thereof on executive compensation derived from one or more Proxy filings submitted to the SEC by one or more companies. The exemplary report 400 can show “Main Report (FY-1)” subtitle 404 signifying that this is one type of report for the last fiscal year that information may be available for. As indicated by “Proxy Compensation Three Year Report” title 402, information from the past three years of Proxy filings may be accessible from interface 400. For example, a user may link to reports (report sections) entitled “Main Report”, “Plan-Based Awards”, “Own[er] & Out[sider] Equity”, “Company Index”, “Executive Bios”, and “EmpI[oyment] Agreements” for each of the past three years (“FY-1”, “FY-2” and “FY-3”) as provided by data field 406 and associated hyperlinks. Additionally, “Save Query” button 412 and “Download” button 414 may be disposed on the interface of report 400 and may allow a user to save their search query or download the presented report as, for example, a spreadsheet document, respectively. An embodiment may allow for a user to change the display of the report to account for new SEC regulations, the old SEC regulations or a combination of the two as this functionality is provided here by radio buttons 407.

Referring now to the “Total Compensation (FY-1)” data field 408, information on each executive and overall statistics computed for the executives as a group may be presented in tabular form. Information pertaining to each executive may include “Name”, “Title”, “Total Direct Compensation (Potential)”, “Total Direct Compensation (As Reported)”, “Period” and the like known to one having ordinary skill in the art as well as whether the new regulations apply. In regard to overall statistics for executive compensation, data field 408 may show the “Median”, “Mean”, “25th Percentile”, “75th Percentile”, “Minimum”, “Maximum” and any other statistic that may be programmatically computed by one having ordinary skill in the art.

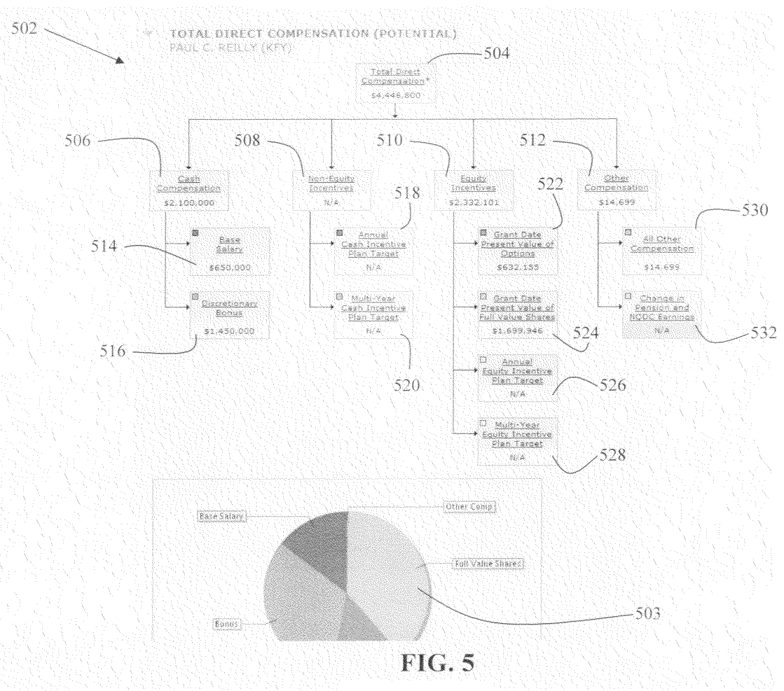

Additionally, report 400 may have “Cash Compensation (FY-1)” data field 410 that may have additional compensation data for each executive, which may include “Name”, whether the new regulations apply and actual “Base Salary”, “Discretionary Bonus”, “Non-Equity Incentive Plan Payouts” as well as potential “Annual Incentive Plan Target Awards”, “Multi-Year Incentive Plan Target Awards” and the like known to one having ordinary skill. Data field 410 may also present this data in tabular form. Additionally data fields that may be incorporated and additionally variations in presenting the data of each report (as well as additional reports themselves) will be readily known to one having ordinary skill in the art and are contemplated by embodiments of the present invention. In at least one embodiment, a user may be able to select (e.g., by pointing to and clicking on with a mouse) data such as compensation data to determine the component data and the mathematical calculation(s) used to compute the data selected by the user. For example, if a user were to select the “$4,446,800” value indicative of the “Total Direct Compensation (Potential)” of “Reilly, P.” as shown on exemplary report 400, then an interface having a tree-like diagram/chart and, optionally, a pier chart as shown in FIG. 5 may be returned and displayed to the user.

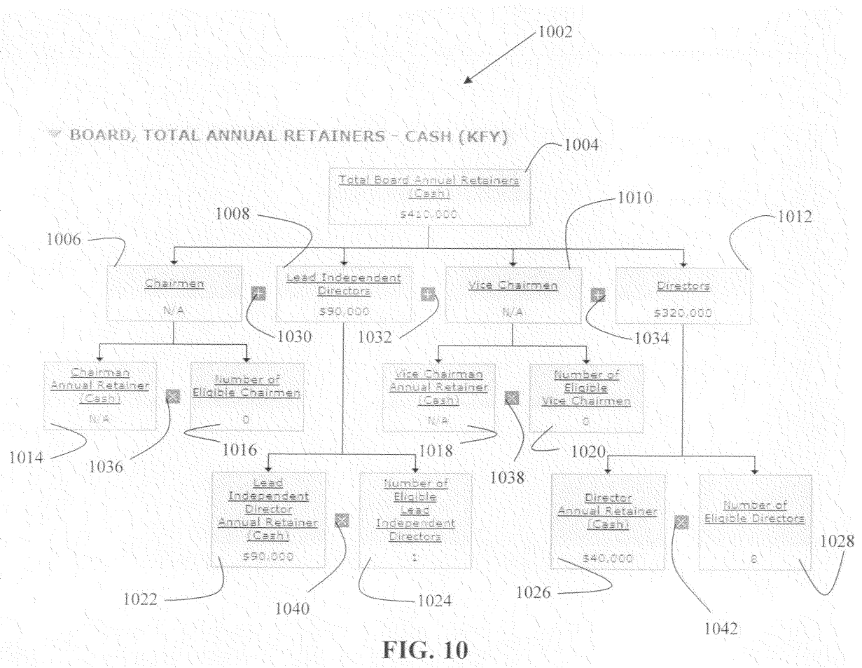

FIG. 5 shows an exemplary representation of a selected numerical value as a function of its component numerical values for use with at least one embodiment of the present invention (See also FIG. 10). Calculation diagram/chart 502 may include data boxes 504, 506, 508, 510, 512, 514, 516, 518, 520, 522, 524, 526, 528, 530 and 532. Calculation diagram/chart 502, in this exemplary embodiment, is shown as a tree-like diagram/chart, nevertheless, any type of diagram, chart, pie, graph, table, hierarchical representation, calculation representation (e.g., in the form of a mathematical equation) and the like known to one having ordinary skill in the art may be used. Diagram 502 has data box 504 showing a “Total Direct Compensation” value of “$4,446,800” as may have been selected in report 400 for “Reilly, P.” Data box 504 can be shown to “branch” into data boxes 506, 508, 510 and 512 showing a “Cash Compensation” value of “$2,100,000”, Non-equity Incentives” value of “N/A” (i.e. zero), “Equity Incentives” value of “$2,332,101” and “Other Compensation” value of “$14,699”, respectively where the calculations are addition calculations. As shown, data boxes 506, 508, 510 and 512 each branch into further data boxes (514, 516, 518, 520, 522, 524, 526, 528, 530 and 532) having values for types of compensation (“Base Salary”, “Discretionary Bonus”, “Annual Cash Incentive Plan Target”, “Multi-Year Cash Incentive Plan Target”, “Grant Date Present Value of Options”, “Grant Date Present Value of Full Value Shares”, “Annual Equity Incentive Plan Target”, “Multi-Year Equity Incentive Plan Target”, “All Other Compensation” and “Change in Pension and NODC Earnings”) used to calculate, by addition, the values of 506, 508, 510 and 512, respectively. Other calculations may include, but are not limited to, subtraction, multiplication and division calculations and other embodiments may include calculation symbols (see FIG. 10). FIG. 5 (and also FIG. 10) show embodiments where all component values (e.g., dollar amounts) may be displayed in a single window. Other embodiments may display any selected and/or component data in various forms known to one having ordinary skill in the art such as pop up windows and/or multi-window embodiments where each value may be selected and a new window may be displayed showing the component data until no further component values are available.

FIG. 5 shows another exemplary representation that may be included with or without tree-like diagram/chart 502, which is pie chart 503 that can have slices corresponding to, among others, “Base Salary”, “Bonus”, “Full Value Shares”, “Other Comp[ensation]” and any other compensation data that is suitable represented in a pie chart known to one having ordinary skill in the art.

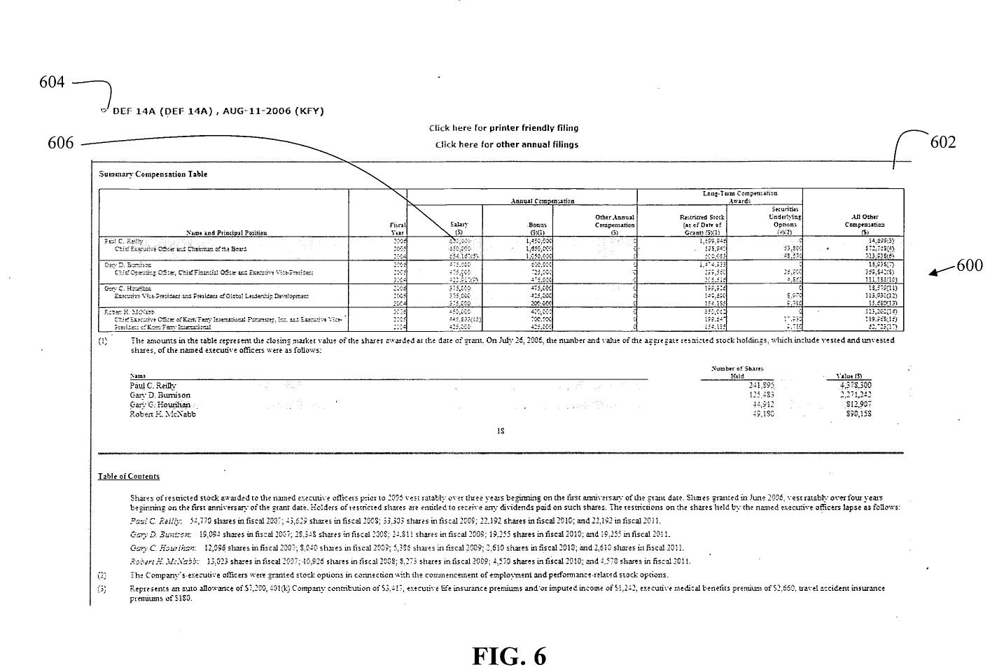

In at least one other embodiment, a user may select (e.g., click-on) a value (or other corporate regulatory-related data) presented in calculation diagram/chart 502 and may be directed to an exemplary interface that can show, for instance, all or part of a SEC filing(s) where the value (or other corporate regulatory-related data) can be found and, optionally, the value (or other corporate regulatory-related data) may be highlighted or otherwise made to “stand out” for easier viewing. This functionality may be a result of a previous capture (e.g., by “tagging” and “parsing”) of corporate regulatory-related data in, for example, HTML formatted documents as discussed above in connection with FIG. 2. For example, if a user were to select the “$650,000” value, an exemplary interface having an exemplary captured portion of a filing such as shown in FIG. 6 may be displayed.

FIG. 6 depicts at least one exemplary embodiment of the present invention where corporate regulatory-related data may be displayed as a portion of an SEC filing. Portion 600 shows “Summary Compensation Table” data field 602, which may be a captured (by “tagging” and “parsing”) summary compensation table portion of a DEF 14A filing (i.e. “Proxy” filing) for “KFY” as indicated by title 604 reading “DEF 14A (DEF 14A), AUG-11-2006 (KFY).” Within “Summary Compensation Table” data field 602, value 606 (i.e. “$650,000”) may be highlighted or otherwise made to “stand out” so that a user may view where the component value(s) (or other corporate-regulatory data) selected from diagram 500 was found originally. This end-to-end confirmation may give a user increased confidence in the corporate regulatory-related data selected because a user may view all or part of the original source document and where the original component data (or other corporate regulatory-related data) may be found.

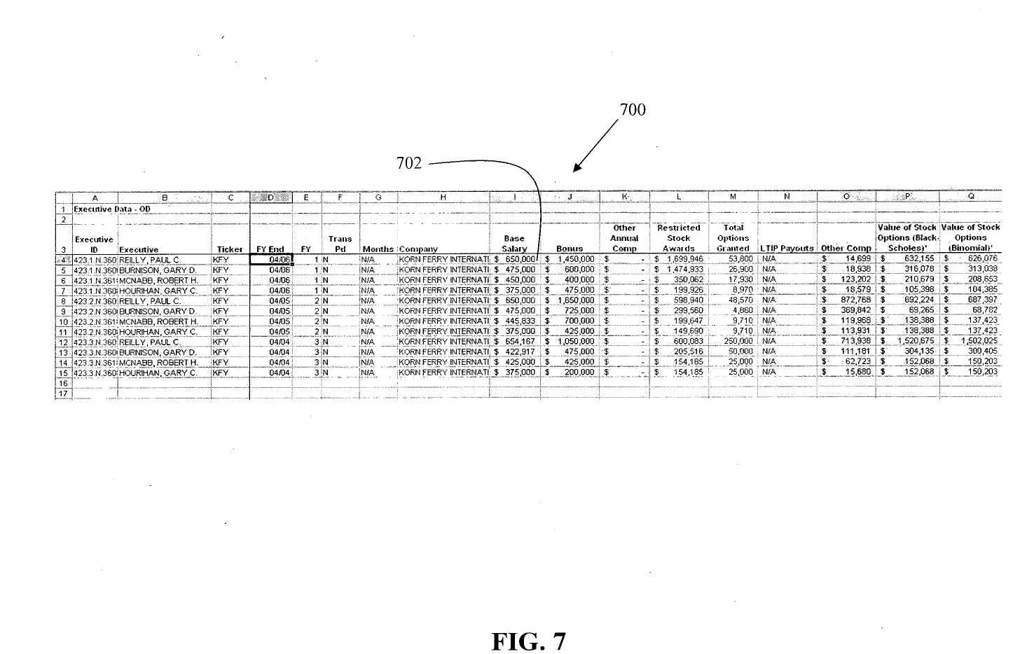

Referring again to FIG. 4, a user may choose to download a report, for example, in a spreadsheet file format by, for instance, selecting “Download” button 414 disposed on report interface 400. By selecting “Download” button 414, a user may be presented with various options including various types of electronic format options for downloading the report. For example, after a user selects “Download” button 414, a pop up window/menu may be displayed where the user may further select a “SureSource Enabled” option, among other alternatives, so that a user can download a SureSource enabled Microsoft Excel spreadsheet document file. Upon selecting the “SureSource Enabled” option, a user may be presented with the option of opening or saving the spreadsheet file. An opened exemplary portion of a spreadsheet file is shown as displayed in the exemplary screenshot of FIG. 7.

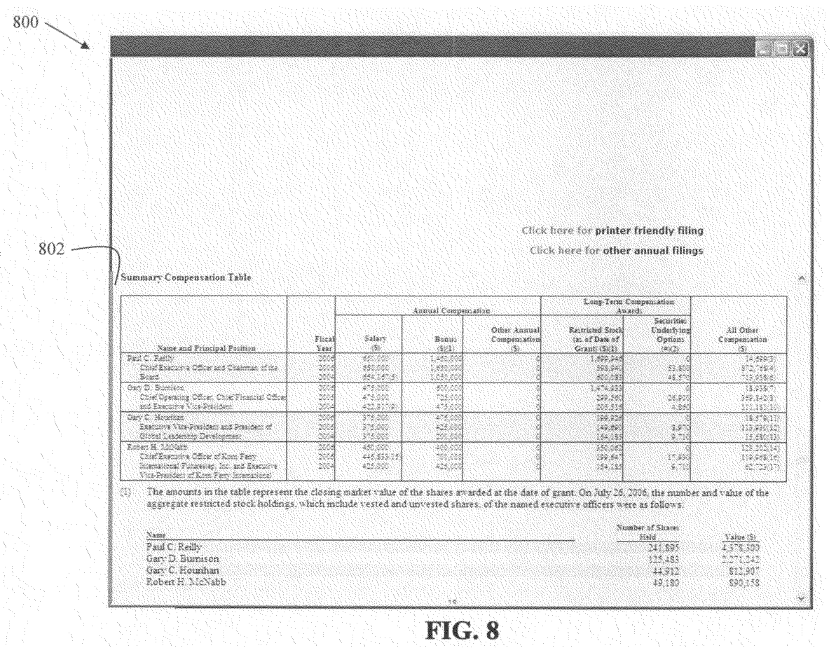

FIG. 7 shows one exemplary spreadsheet file according to at least on exemplary embodiment of the present invention where a user may hyperlink from a corporate regulatory-related data (e.g., numerical value) to the source corporate regulatory-related data (e.g. all or part of an SEC filing(s)) as shown in FIG. 6 that may be displayed in a window similar to exemplary window 800 of FIG. 8. Optionally, the value may be highlighted within all or part of the SEC filing(s) that may be displayed. For example, spreadsheet 700 shows that “$650,000” is value 702 for the “Base Salary” of “Reilly, Paul C.” By selecting value 702 and selecting to view the source corporate regulatory-related data, for instance, a user may use a mouse to right-click on value 702 and then may select “View SEC filing” from a menu, the value is linked to the source SEC filing. FIG. 8 shows an exemplary window showing exemplary captured portion 600 of FIG. 6 displayed as a result of linking from value 702 of spreadsheet file 700.

Like FIG. 6, FIG. 8 shows “Summary Compensation Table” data field 802, which may be a captured (by “tagging” and “parsing”) summary compensation table portion of a “Proxy” filing for “KFY” as indicated by the title reading “DEF 14A (DEF 14A), AUG-11-2006 (KFY).” Within “Summary Compensation Table” data field 802, the numerical value “$650,000” may be highlighted or otherwise made to “stand out” so that a user may view where the component value (or other corporate-regulatory data) selected from diagram/chart 502 was found originally. This end-to-end confirmation may give a user increased confidence in the corporate regulatory-related data selected because a user may view all or part of the original source document and where the original component data (or other corporate regulatory-related data) may be found.

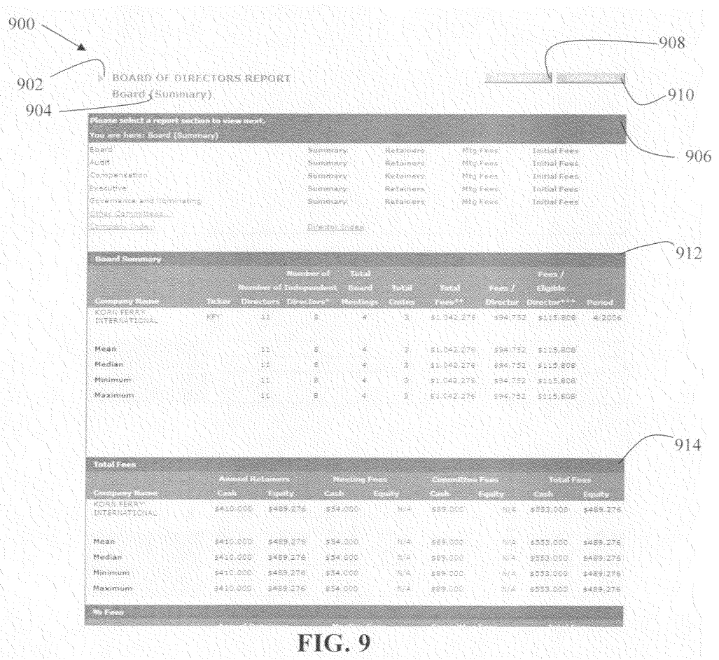

FIGS. 9 and 10 generally refer to, as another non-limiting example, corporate regulatory-related data, such as compensation data, in regard to the board of directors for a corporation(s). As discussed above, these exemplary embodiments are merely illustrative and one having ordinary skill in the art will understand the embodiments of the invention may be used to analyze various types of information produced by public and non-public entities including a plurality of corporate regulatory-related data. For example, after entering a search query that may be accomplished by using a search interface similar to exemplary search query interface 300 of FIG. 3, a report on the board of directors for a company(ies) may be returned.

FIG. 9 shows at least one other exemplary embodiment that may display a report (or portion thereof) on compensation for a board of directors. For example, report 900 (or portion thereof) shown in FIG. 9 can be the result of a search on board compensation for “KFY”. The exemplary report 900 may show “Board of Directors Report” title 902 and may also show “Board (Summary)” subtitle 904 signifying that this is one type of report that information may be available for. Additional reports may also be available as shown in data field 906 with associated hyperlinks that can return the reports. For example, a user may link to a “Summary” report, “Retainers” report, “Mtg Fees” report and “Initial Fees” report for potentially each of the “Board”, “Audit” committee, “Compensation” committee, “Executive” committee and “Governance and Nominating” committee as well as to “Other Committees”, “Company Index”, “Director” index and any other like information known to one having ordinary skill in the art. Additionally, “Save Query” button 908 and “Download” button 910 may be disposed on report interface 900 and may allow a user to save their search query or download the presented report as, for example, a spreadsheet document, respectively. A spreadsheet file for the report can also have the same functionality and ability to provide end-to-end confirmation of the numbers displayed within the spreadsheet as previously discussed.

Referring now to “Board Summary” data field 912, information on the board of directors and compensation statistics may be computed and shown and further may be presented in tabular form. Information pertaining to the board may include “Company Name”, stock “Ticker” symbol, “Number of Directors”, “Number of Independent Directors”, “Total Board Meetings”, “Total Cmtes”, “Total Fees”, “Fees/Director”, “Fees/Eligible Directors”, “Period” and the like known to one having ordinary skill in the art. In regard to compensation statistics, data field 910 may show the “Median”, “Mean”, “Minimum”, and “Maximum” statistics for any of the information presented in data field 910 as well as any other statistic that may be programmatically computed by one having ordinary skill in the art.

Additionally, report 900 may have “Total Fees” data field 914 that may have additional compensation data for the board, which may include “Company Name”, “Annual Retainers” (in cash and equity), “Meeting Fees” (in cash and equity), “Committee Fees” (in cash and equity), “Total Fees” (in cash and equity) and the like known to one having ordinary skill. Data field 914 may also present this data in tabular form. Additionally data fields that may be incorporated and additionally variations in presenting the data of each report (as well as additional reports themselves) will be readily known to one having ordinary skill in the art and is contemplated by embodiments of the present invention. In at least one embodiment, a user may be able to select (e.g., by pointing to and clicking on with a mouse) data such as compensation data to determine the component data and the mathematical calculation(s) used to compute the data selected by the user. For example, if a user were to select the “$4100,000” value indicative of the of annual retainers in cash as shown on exemplary report interface 900, then an calculation diagram/chart such as shown in FIG. 10 may be returned and displayed to the user.

Similar to FIG. 5, FIG. 10 shows exemplary calculation diagram/chart 1002 of at least one exemplary embodiment of the present invention where a value is shown as a function of the component data (e.g., numerical values) of the selected value. Calculation diagram/chart 1002 may include data boxes 1004, 1006, 1008, 1010, 1012, 1014, 1016, 1018, 1020, 1022, 1024, 1026 and 1028 as well as calculation symbols 1030, 1032, 1034, 1036, 1038, 1040 and 1042. Diagram/chart 1002, in this exemplary embodiment, is shown as a tree-like diagram/chart, nevertheless, any type of diagram, chart, graph, pie, table, hierarchical representation, calculation representation (e.g., in the form of a mathematical equation) and the like known to one having ordinary skill in the art may be used. FIG. 10 (and also FIG. 5) show embodiments where all component values (e.g., numerical values) may be displayed in a single window. Other embodiments may display any selected and/or component data in various forms known to one having ordinary skill in the art such as pop up windows and/or multi-window embodiments where each value may be selected and a new window may be displayed showing the component data until no further component values are available.

As shown in the calculation diagram/chart 1002 the value in data box 1004 representing the “Total Board Annual Retainers (Cash)” is the result of adding the values in data boxes 1006, 1008, 1010 and 1012 for “Chairman”, “Lead Independent Directors”, “Vice Chairman” and Directors”, respectively. The additional computation is represented by calculation symbols 1030, 1032 and 1034. Additional component values for each of the values in data boxes 1006, 1008, 1010 and 1012 may also be shown. For example, the “$320,000” value of data box 1012 (“Directors”) may be computed by multiplying, as may be signified by calculation symbol 1042 denoting a multiplication calculation, the value (“$40,000”) of data box 1026 for “Director Annual Retainer (Cash)” by the value (“8”) of data box 1028 for “Number of Eligible Directors”.

In at least one other embodiment, a user may select (e.g., click-on) a value (or other corporate regulatory-related data) presented in chart/diagram 1002 and may be directed to an exemplary interface that can show, for instance, all or part of a SEC filing(s) where the value (or other corporate regulatory-related data) can be found and, optionally, the value (or other corporate regulatory-related data) may be highlighted or otherwise made to “stand out” for easier viewing. This functionality may be a result of a previous capture (e.g., by “tagging”) of corporate regulatory-related data in, for example, HTML formatted documents as discussed above in connection with FIG. 2.

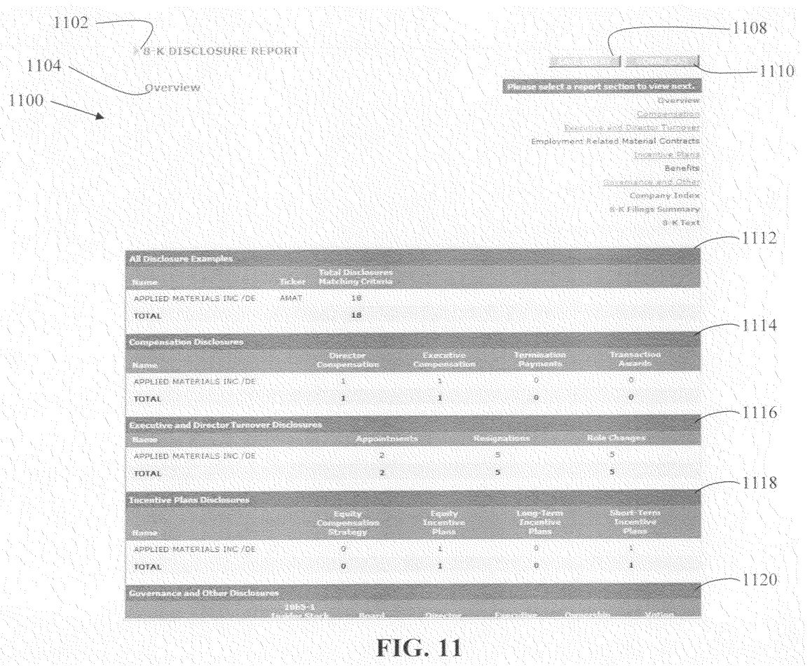

FIGS. 11-13 generally are directed to how embodiments of the present invention may be used to analyze textual corporate regulatory-related data (as opposed to numerical values and/or compensation data). As yet another non-limiting example, FIGS. 11-13 are directed, in part, to textual corporate regulatory-related data (e.g., statements) found within 8-K filings. As discussed above, these exemplary embodiments are merely illustrative and one having ordinary skill in the art will understand the embodiments of the invention may be used to analyze various types of information produced by public and non-public entities including a plurality of corporate regulatory-related data.

FIG. 11 shows another exemplary report of at least one exemplary embodiment of the present invention where a user may have entered a search on the 8-K filings of Applied Materials, Inc. The exemplary report interface 1100 may show “8-K Disclosure Report” title 1102 and may also show “Overview” subtitle 1104 signifying that this is one type of report that information may be available for. Additional reports and information may also be available as shown in data field 1106 with associated hyperlinks that can return the reports. For example, a user may also link to a “Compensation” report, “Executive and Director Turnover” report, “Employment Related Material Contracts” report, “Incentive Plans” report, “Benefits” report, “Governance and Other” report(s), “Company Index” report, “8-K Filings Summary” report, “8-K Text” report and any other like reports or information known to one having ordinary skill in the art. Additionally, “Save Query” button 1108 and “Download” button 1110 may be disposed on report interface 1100 and may allow a user to save their search query or download the presented report in various file formats with the ability to link to source corporate regulatory-related data from the regulatory-related data that may be displayed in numerous file formats known to one having ordinary skill in the art.

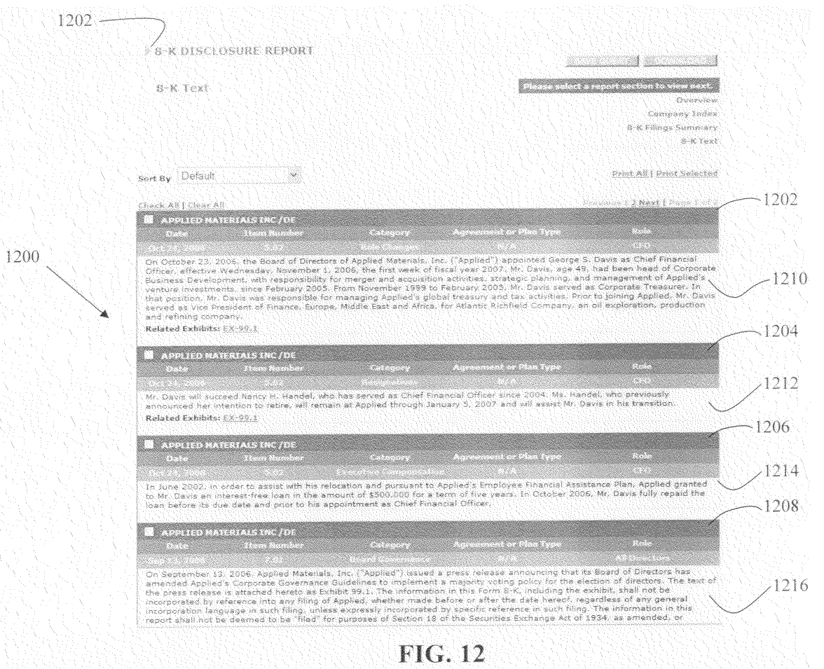

Referring now to “All Disclosure Examples” data field 1112 on report 1100 where information may be presented in tabular form. Information may include company(ies) name(s), ticker symbol, total disclosures matching criteria per company and total disclosures overall and the like known to one having ordinary skill in the art. Additional data fields such as “Compensation Disclosures” data field 1114, “Executive and Director Turnover Disclosures” data field 1116, “Incentive Plan Disclosures” data field 1118, “Governance and Other Disclosures” data field 1120 and like known to one of ordinary skill in the art may also be on report 1100. Information may be presented in one or more tables and in one or more tabular forms and can include director compensation disclosure, executive compensation disclosures, termination payments disclosures, transaction awards disclosures, appointments disclosures, resignation disclosure, role changes disclosures, equity compensation strategy disclosures, equity incentive plans disclosures, long-term incentive plans disclosures, short-term incentive plans disclosures and the like known to one having ordinary skill in the art. A user interested in textual corporate regulatory-related data identified in, for instance, 8-K filings may select the “8-K Text” hyperlink in data field 1106 and may be returned an interface such as is shown in the exemplary embodiment of FIG. 12.

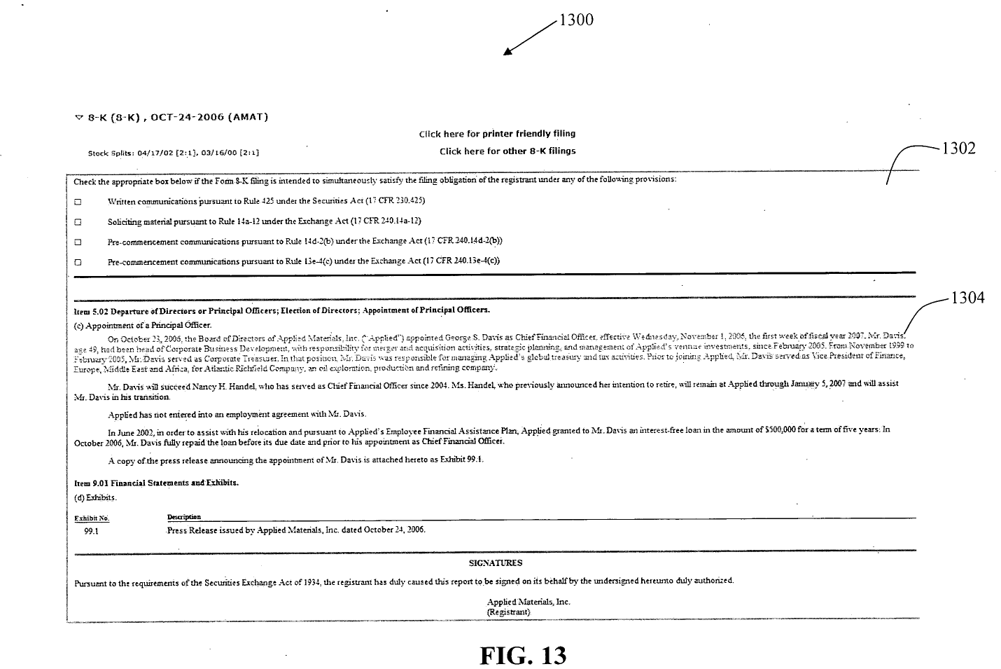

FIG. 12 shows an exemplary portion of an interface of at least one exemplary embodiment of the present invention. As shown in captured portions fields 1200, data fields 1202, 1204, 1206 and 1208 can contain corporate regulatory-related data items 1210, 1212, 1214 and 1216, respectively. Each data item may have been identified and captured using manual HTML “tagging” techniques and/or automatic parsers as described in connection with FIG. 2. Also, within each data field 1202, 1204, 1206 and 1208 information pertaining to the date of the filing, item number(s), category, agreement or plan type, role and the like known to one having ordinary skill in the art may be included. By selecting (e.g., by pointing to and clicking on the text of), for instance, data item 1210 a user may be directed to an exemplary interface like that of FIG. 13.

FIG. 13 shows exemplary interface 1300 having a portion(s) of a filing for at least one exemplary embodiment of the present invention where a user may view the source (or original) corporate regulatory-related data. Data field 1302 may show all or a portion of, for example, a 8-K filing that may have been identified and captured using HTML tags as described in connection with FIG. 2. In this example, data item 1304 of the original 8-K filing contains the same information as data item 1210 of FIG. 12. Optionally, data item 1304 may be highlighted or otherwise made to “stand out” to allow for easier viewing by a user. Overall, this end-to-end confirmation may give a user increased confidence in the corporate regulatory-related data selected because a user may view all or part of the original source document and where the original corporate regulatory-related data may be found.

At least one embodiment of the present invention discloses a system and method for identifying, storing and returning corporate regulatory-related data. At least one embodiment may include identifying a plurality of corporate regulatory-related data and generating a plurality of HTML tags for the plurality of corporate regulatory-related data. Optionally, embodiments may include storing the plurality of HTML tags in one or more databases. Embodiments may also return corporate regulatory data in response to a search query.

At least one embodiment of the present invention may include identifying corporate regulatory-related data, partly, by parser programs/scripts, together with, or, alternatively through, manual identification. Other embodiments may include corporate regulatory-related data found within SEC filings and as full SEC filings. At least one embodiment responds to the selection of corporate regulatory-related data by returning portions (e.g., captured) of SEC filings. At least one embodiment allows for downloading of the corporate regulatory-related data into, for instance, spreadsheet format.

When the corporate regulatory-related data is in the form of numerical corporate regulatory-related values calculated from two or more component numerical corporate regulatory-relate values that may be contained in the source documents, at least one embodiment responds to the selection of the numerical corporate regulatory-related value by returning the component numerical values. Further, at least one embodiment responds to the selection of the component numerical values by returning portions of source documents containing the component numbers.

Also, at least one embodiment of the present invention discloses a system and method for searching and analyzing corporate regulatory-related data. The embodiment is, preferably, in a distributed network and may include entering a user-generated search query from one or more client computers. Optionally, the embodiment may include accessing corporate regulatory-related data from one or more storage mediums having a plurality of corporate regulatory-related data, HTML tags and captured portions of source documents. A report may be displayed containing corporate regulatory-related data to one or more client computers and it may be responsive to a user selecting corporate regulatory-related data from the one or more client computers. Additionally, it may access captured (e.g., having a HTML tag(s)) portions of a source document containing the corporate regulatory-related data in response to the user selecting a corporate regulatory-related data. The captured portion may be displayed on one or more client computers.

In at least one embodiment, the report may be downloaded (e.g., into spreadsheet format file) and the corporate regulatory-related data therein may be linkable to portions of the source documents. In other embodiments, the corporate-regulatory related data may be a numerical value computed by two or more component numerical corporate regulatory-related values that may be furthered accessed and displayed. Upon selection of the numerical value, a user may view the component numerical values that are linkable to portions of the source documents.

In yet at least one other embodiment of the invention a computer program product for returning corporate regulatory-related data is disclosed. At least one embodiment may include a computer storage medium and a computer program code mechanism embedded in the computer storage medium. The computer program mechanism may include a computer code device configured to: receive a search query defined by at least one search criteria; run the search query against a plurality of corporate regulatory-related data; return a report having corporate regulatory-related data; allow for the selection of the corporate regulatory-related data; and return a captured portion of a source document having corporate regulatory-related data. Also, at least one embodiment may have a computer code device configure to link from a first report to one or more other reports having different corporate regulatory-related data.

In at least one embodiment, a computer code device may be configured to allow for the selection of the at least one numerical value and may return component numerical values that were used to compute that originally selected numerical value. Moreover, in at least one embodiment, a computer code device may be configured to display the at least original numerical value and component numerical values in a tree-like diagram that may include calculation symbols.

In at least one embodiment, a computer code device may be configured to download reports into spreadsheet format where computer regulatory-related data viewed in the spreadsheet file may be able to be selected and a computer code device may be configured to return portions of the original source document when users select the corporate regulatory-related data.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of identifying, storing and returning corporate regulatory-related data, comprising:
identifying a plurality of corporate regulatory-related data;
generating a plurality of tags for the plurality of corporate regulatory-related data;
storing the plurality of tags in one or more databases; and
returning at least one corporate regulatory-related data in response to a search query.

2. The method of claim 1, wherein the plurality of corporate regulatory-related data is found within a plurality of source SEC filings having a plurality of portions.

3. The method of claim 2, wherein identifying a plurality of corporate regulatory-related data is done in part by one or more parsers for programmatically identifying corporate regulatory-related data.

4. The method of claim 2, further comprising:
responding to the selection of the at least one corporate regulatory-related data; and
returning at least one portion of at least one source SEC filing.

5. The method of claim 4, further comprising:
downloading the at least one corporate regulatory-related data.

6. The method of claim 2, wherein the at least one corporate regulatory-related data is at least one numerical corporate regulatory-related value calculated from two or more component numerical corporate regulatory-related values contained within at least one portion of at least one SEC filing.

7. The method of claim 6, further comprising:
responding to the selection of the at least one numerical corporate regulatory-related value; and
returning the two or more component numerical corporate regulatory-related values.

8. The method of claim 7, further comprising:
responding to the selection of a component numerical corporate regulatory-related value; and
returning at least one portion of at least one SEC filing containing the component numerical corporate regulatory-related value.

9. A computer program product for returning corporate regulatory-related data, comprising:
a computer storage medium; and
a computer program code mechanism embedded in the computer storage medium for causing a computer to return one or more corporate regulatory-related data, the computer program code mechanism comprising:
a computer code device configured to receive a search query defined by at least one search criteria;
a computer code device configured to run the search query against a plurality of corporate regulatory-related data;
a computer code device configured to return a first report having at least one corporate regulatory-related data;
a computer code device configured to allow for the selection of the at least one corporate regulatory-related data; and
a computer code device configured to return at least one captured portion of a source document containing the at least one corporate regulatory-related data.

10. The computer program product of claim 9, wherein the at least one corporate regulatory-related data is a numerical value computed from two or more component corporate regulatory-related data values.

11. The computer program product of claim 10, wherein the computer program code mechanism further comprises:
a computer code device configured to allow for the selection of the numerical value; and
a computer code device configured to return the two or more component corporate regulatory-related data values used to compute the numerical value.

12. The computer program product of claim 11, wherein the computer program code mechanism further comprises:
a computer code device configured to display the numerical value and the two or more component corporate regulatory-related data values in a tree-like diagram.

13. The computer program product of claim 9, wherein the computer program code mechanism further comprises:
a computer code device configured to download the at least one computer regulatory-related data into a spreadsheet;
a computer code device configured to respond to the selection of the at least one computer regulatory-related data downloaded into the spreadsheet; and
a computer code device configured to return at least one captured portion of a source document containing the at least one corporate regulatory-related data.

14. The computer program product of claim 9, wherein the computer program code mechanism further comprises:
a computer code device configured to link from the first report to one or more second reports having at least one other corporate regulatory-related data.

15. A method of searching and analyzing corporate regulatory-related data, comprising:
entering a user-generated search query from one or more client computers in a distributed network;
accessing at least one corporate regulatory-related data from one or more storage mediums having a plurality of corporate regulatory-related data, a plurality of HTML tags and a plurality of source documents having a plurality of captured portions;
displaying at least one report containing the at least one corporate regulatory-related data on the one or more client computers; and
responding to a selection of a corporate regulatory-related data by a user from the one or more client computers.

16. The method of claim 15, further comprising:
accessing at least one first captured portion of at least one first source document containing the corporate regulatory-related data, wherein the at least one first captured portion is identified by at least one HTML tag.

17. The method of claim 16, further comprising:
displaying the at least one first captured portion of the at least one first source document on the one or more client computers.

18. The method of claim 15, further comprising:
downloading the at least one report into a spreadsheet on the one or more client computers.

19. The method of claim 15, further comprising:
accessing two or more component corporate regulatory-related data, whereby the two or more component corporate regulatory-related data mathematically define the corporate regulatory-related data; and
displaying the two or more component corporate regulatory-related data on the one or more client computers.

20. The method of claim 19, further comprising:
responding to the selection of the two or more component corporate regulatory-related data by a user from the one or more client computers; and
displaying at least one second captured portion of at least one second source document on the one or more client computers.

21. The method of claim 15, wherein the at least one corporate regulatory-related data has at least one executive compensation data.
